(19) United States
(12) Patent Application Publication
(10) Pub. No.: US 2006/0048992 A1
(43) Pub. Date: Mar. 9, 2006

(54) Longitudinal four wheel drive train

(76) Inventors: Philip Gansloser, Bad Ditzenbach (DE); Tobias Harter, Fellbach (DE); Werner Klein, Winnenden (DE); Hartmut Nied, Waiblingen (DE); Rolf Schroder, Stuttgart (DE); Petra Tennert, Gerlingen (DE)

Correspondence Address: KLAUS J. BACH, 4407 TWIN OAKS DRIVE, MURRYSVILLE, PA, 15668, US

(21) Appl. No.: 11/245,941

(22) Filed: Oct. 7, 2005

Related U.S. Application Data
(63) Continuation-in-part of application No. PCT/EP04/01819, filed on Feb. 18, 2004.

(30) Foreign Application Priority Data
Apr. 8, 2003 (DE) 103 15 884.7

(51) Int. Cl. B60K 17/34

(52) U.S. Cl. 180/233

(57) ABSTRACT

In a longitudinally installed four wheel drive train of a motor which includes a front drive shaft, which transmits the engine driving torque to the front axle from the rear end of the vehicle transmission the front drive shaft comprises at least at its rear end two opposite radially projecting pins extending into longitudinal grooves formed in a gear wheel of a front drive structure so as to be axially movably and pivotally supported therein.

This is a Continuation-In-Part Application of International Application PCT/EP2004/001519 filed Feb. 18, 2004 and claiming the priority of German application 103 15 884.7 filed Apr. 8, 2003.

The invention relates to a longitudinally installed four wheel drive train for a motor vehicle.

A longitudinally installed four wheel drive train, in which a driving torque can be transmitted from the vehicle transmission via a transfer gear structure including a side gear wheel to a lateral drive shaft, is disclosed in EP 123 8847 A1. The lateral drive shaft end disposed at the rear in the vehicle direction is arranged in an articulated manner inside the gearwheel.

A longitudinally installed four wheel drive train is also disclosed in printed publications covering the Volkswagen “Phaeton” with a 5.0 1 V10 TDI PD bi-turbo engine. In this drive train, the lateral shaft is installed without a joint.

It is the object of the invention to provide a longitudinally installed four wheel drive train which is both quiet-running and cost-effective.

### SUMMARY OF THE INVENTION

In a longitudinally installed four wheel drive train of a motor which includes a front drive shaft, which transmits the engine driving torque to the front axle from the rear end of the vehicle transmission the front drive shaft comprises at least at its rear end two opposite radially projecting pins extending into longitudinal grooves formed in a gear wheel of a front drive structure so as to be axially movably and pivotally supported therein.

The joint thus formed can in an especially advantageous way be a bipod joint or a biplane joint. In principle, however, other joint types in which the two pins roll or slide in longitudinal grooves of the gearwheel are also conceivable.

Bipod and biplane joints have the advantage of a predominantly rolling bearing during operation, so that friction, wear, noise generation, heat generation and vibration excitation are kept to a low level. Furthermore, biplane joints and bipod joints are lighter and more cost-effective in comparison with triplane joints and tripod joints.

A biplane or bipod joint can in an especially advantageous way be combined with a conventional universal joint. The biplane or bipod joint can thus be arranged at that end of the lateral shaft lying at the rear in the vehicle direction, while a universal joint is arranged at the front end. In this connection, use can be made of a universal joint such as is already disclosed in European patent application 2014122.2, which is not a prior publication. There, the joint is installed at the rear end of the lateral drive shaft. That is to say, while the biplane or bipod joint is arranged in a space-saving way inside the gearwheel of the lateral output gear, a universal joint is arranged in the region of the front axle differential. In this connection, the universal joint transmits the torque from the lateral shaft to the bevel gear of a bevel gear/ring gear gearing of the front axle differential transmission. This combination of a biplane or bipod joint with a universal joint makes especially uniform motion possible as the biplane or bipod joint and the universal joint have the same characteristic of rotary motion uniformity.

Basically, designing the lateral drive shaft with at least one joint has the advantage that slight tilting movements of the lateral shaft do not lead to stresses within the driveshaft. Consequently, no forces resulting from such stresses are introduced into the bearing assembly of said gearwheel either. Consequently, this bearing assembly has to support only the forces which result from the driving torque transmission on the gearing pairing of the lateral output. By virtue of this quasi-freedom of the gearing pairing from external forces, this gearing pairing runs very quietly and free from vibrations. If necessary, the bearing assembly of said gearwheel must still support axial forces which are introduced into the bearing assembly from the lateral drive shaft. However, in an especially advantageous development of the invention, these axial forces can be eliminated by virtue of the fact that the lateral shaft is of two-part design, the two lateral shaft halves being axially movable in relation to one another. To this end, a shaft/hub axial gearing as is disclosed in EP 2027809.9 can be provided, for example.

In an especially advantageous embodiment of the invention the longitudinal axis of the two pins assigned to the rear lateral shaft end is arranged parallel in relation to the longitudinal axis of the pins assigned to the front lateral shaft end so that a uniform rotary motion of the lateral shaft is achieved. For reasons of constructional space,
the axis of rotation of said gearwheel or output pinion,
the longitudinal axis of the lateral shaft and
the axis of rotation of the front pinion shaft of the front axle differential
   are in many cases not aligned with one another, that is, they are arranged at an angle to one another. In this connection, the three geometrical axes mentioned above may be positioned in a W arrangement or a Z arrangement in relation to one another, for example. In these cases, exactly parallel arrangement of the pin axis at the front end to the pin longitudinal axis at the rear end would lead to non-uniform rotation. For this reason, the two pin longitudinal axes are inclined relative to one another by a small angle α of not more than 5°.

In an embodiment of the invention which constitutes an especially favorable configuration as far as driving torque introduction into said gearwheel is concerned, the two pins assigned to a lateral shaft end are connected in a motionally fixed manner to the lateral shaft. On the other hand, however, rotatable mounting of the two pins in a bore of the lateral shaft end is also possible.

The invention will become more readily apparent from the following description of an illustrative embodiment thereof with reference to the accompanying drawings:

### BRIEF DESCRIPTION OF THE DRAWINGS

FIG. 1 shows diagrammatically a longitudinally installed four wheel drive train with two joints, which can be in the form of biplane joints or bipod joints, one joint being arranged inside a slightly conical gearwheel;

FIG. 2 shows a part region of the four wheel drive train of FIG. 1 in detail in a section along a drive train longitudinal axis, the joint arranged inside the gearwheel being a biplane joint;

FIG. 3 shows the biplane joint of FIG. 2 in detail, the slight conicity of the gearwheel not being illustrated for the sake of simplification;

FIG. 4 shows the biplane joint of FIG. 3 in a section which extends at right angles to the section plane according to FIG. 2 and FIG. 3;

FIG. 5 shows the biplane joint of FIG. 2 to FIG. 4 in a perspective view;

FIG. 6 shows a bipod joint, which can find application in a four wheel drive train according to FIG. 1 and FIG. 2 instead of the biplane joint;

FIG. 7 shows a detail of the bipod joint according to FIG. 6;

FIG. 8 shows a second embodiment of a bipod joint, which differs from the first illustrative development of the bipod joint according to FIG. 6 in the nature of the centering;

FIG. 9 shows a third embodiment of a bipod joint, which differs from the alternative developments according to FIG. 6 and FIG. 8 principally in the nature of the centering;

FIG. 10 shows a second embodiment of a biplane joint, which is illustrated in the same section plane as FIG. 4;

FIG. 11 shows the biplane joint according to FIG. 10 in a sectional plane at right angles to the sectional plane according to FIG. 10;

FIG. 12 shows a bipod joint which includes constructional elements of the bipod joint according to FIG. 8 and of the biplane joint according to FIG. 10;

FIG. 13 shows a bipod joint which has been developed further in relation to the previous bipod joint, and

FIG. 14 to show diagrammatically a lateral

FIG. 16 shaft with a pinion shaft and an output pinion in an aligned arrangement, in a Z arrangement and in a W arrangement.

In the following description, the directional indications “rear” and “front” designate the direction pointing toward the rear and toward the front respectively in the direction of travel of a vehicle.

### DESCRIPTION OF PARTICULAR EMBODIMENTS

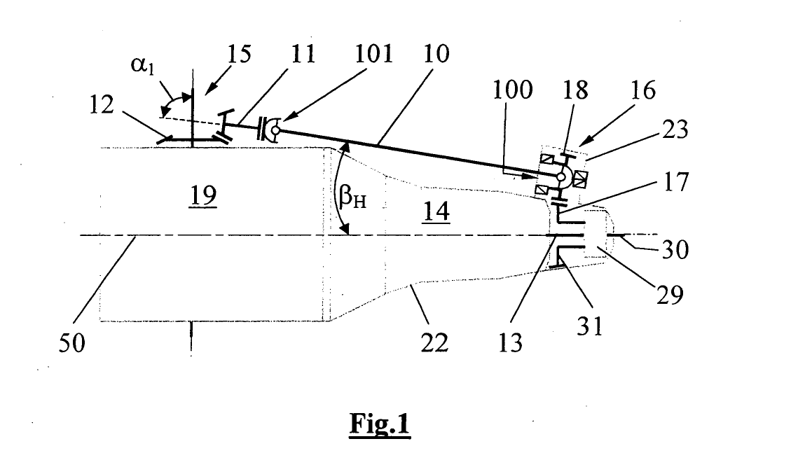

FIG. 1 is a diagrammatic illustration of a longitudinally installed drive train according to the invention for a motor vehicle, which comprises a drive engine 19 and an automatic transmission 14 with a transmission output shaft 13 which faces toward the rear of the motor vehicle when installed. The drive train is orientated essentially along a drive train longitudinal axis 50.

The automatic transmission 14 is basically designed for rear drive vehicles. In the installed state of the automatic transmission 14, the transmission output shaft 13 is drive-connected to an input shaft (not illustrated in greater detail) of a rear axle differential transmission.

The automatic transmission 14 has a transmission case 22 with a formed-on bearing housing 23 for a lateral output 16, so that the automatic transmission 14 can be used cost-effectively for a four wheel drive car according to the “add-on principle”.

In such a variant, the transmission output shaft 13, which is extended in relation to the pure rear drive variant, is connected to the pinion shaft of the rear axle transmission via a transfer gear structure 29 and a rear drive shaft 30 in such a way that a first part of the driving torque is transmitted to the rear axle transmission. A second part of the driving torque is transmitted from the transmission output shaft 13 via
the transfer transmission 29,
a driving pinion 17,
a drive shaft 10 of the lateral output 16 and
a bevel pinion shaft 11 of a front axle drive 15 to a front axle differential. Output torques can be distributed to the front differential transmission 15 and the rear axle differential and rotational speed differences between the front and rear axles can be compensated by means of the transfer differential transmission 29.

The drive shaft 10 of the lateral output 16 is pivoted horizontally by an angle of roughly 8° in relation to the transmission output shaft 13, to be precise in the direction of the bevel pinion shaft 11 of the front axle transmission 15. The drive shaft 10 of the lateral output 16 is pivoted vertically by an angle of roughly 4° in relation to the transmission output shaft 13, to be precise in the direction of the bevel pinion shaft 11 of the front axle differential transmission 15. In this connection, only the angle β_{H} in the horizontal can be seen in the drawing.

The lateral output 16 is formed by two gears, to be precise by a driving pinion 17 and an output pinion 18 meshing with it. The driving pinion 17 is connected in a rotationally fixed manner to a transmission element of the transfer transmission 29 by means of a hollow shaft 31. The transmission output shaft 13 extends inside this hollow shaft 31. The output pinion 18 is mounted in the bearing housing 23 by means of a preloaded tapered-roller bearing assembly in an x arrangement.

To extend at the horizontal angle β_{H} and the vertical angle (not illustrated), the drive shaft 10 is arranged in an articulated manner radially inside the output pinion 18 by means of a bipod joint 100. Furthermore, the drive shaft 10 is at the front in the direction of travel—i.e. at its other end—coupled in an articulated manner to the bevel pinion shaft 11 with a further bipod joint 101.

In the drive train, the driving pinion 17 and the output pinion 18 meshing with it are each in the form of a conical spur gear. In this connection, an axis angle of these conical spur gears is the same as the horizontal angle β_{H}. Furthermore, an axis angle α₁ of a ring gear 12 and of the bevel pinion shaft 11 is smaller than 90° by the angle β_{H}, so that the shaft of bevel pinion shaft 11 and the drive shaft 10 lie in a common vertical plane. The drive shaft 10 is arranged on the right side of the drive engine 19 in the direction of travel. The ring gear 12 of the front axle differential transmission 15 is arranged on that side of the front axle transmission 15 adjacent the drive engine 19—i.e. on the left side the differential transmission 15 in the direction of travel.

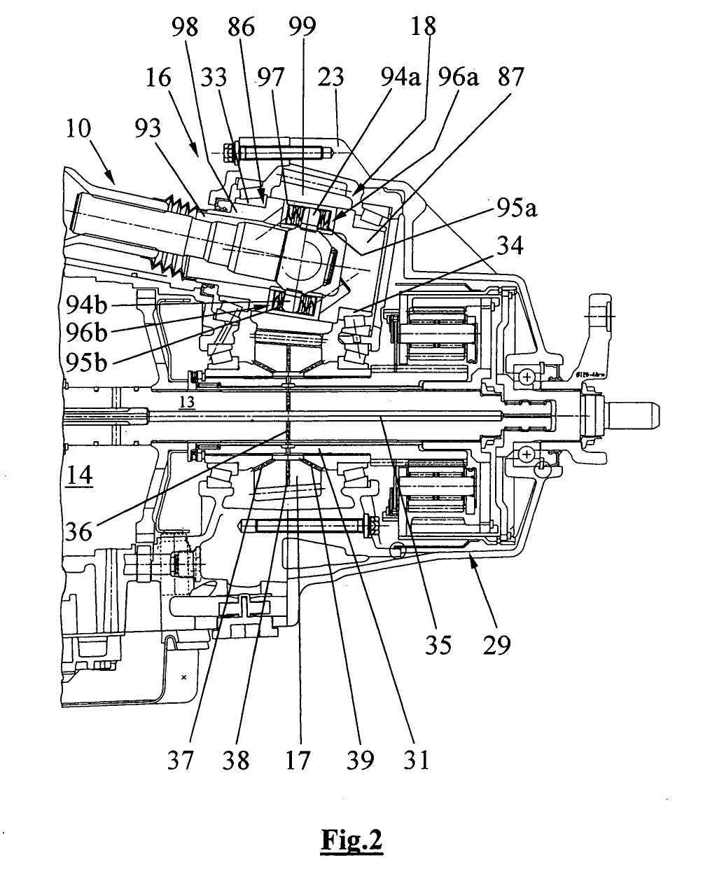

FIG. 2 shows in detail a part of the four wheel drive train of FIG. 1 in a sectional view.

In particular the lateral power output 16 with the bearing housing 23 can be seen in FIG. 2. The driving pinion 17 and the output pinion 18 meshing with it are each in the form of a bevel gear. In this connection, an axis angle of these bevel gears is the same as a horizontal angle β_{H} of the drive shaft 10 of the lateral output 16.

The transmission output shaft 13 is in the form of a hollow shaft and arranged coaxially with the radially outer hollow shaft 31, an annular channel remaining between the two hollow shafts. The driving torque of the only partly visible automatic transmission 14 is transmitted to a transfer transmission 29, which distributes the driving torque on the one hand to a pinion shaft (not illustrated detail) of a rear axle differential transmission and on the other hand to the hollow shaft 31. The driving pinion 17 is fitted onto this hollow shaft 31 in a rotationally fixed manner, secured axially and mounted in the bearing housing 23 by means of a tapered-roller bearing assembly in an x arrangement. The bearing housing 23 also accommodates the tapered-roller bearing assembly in which the output pinion 18 is mounted. The output pinion 18 consists of a gear ring 99 and a hollow shaft insert 86 pressed into the latter. To prevent microslip, the shaft insert 86 is additionally welded together with the toothed ring 99. Alternatively, a driving gearing can also be provided to prevent microslip.

The shaft insert 86 has approximately centrally a region of greatest diameter, on which the gear ring 99 is pressed on. From this region, the shaft insert 86 tapers stepwise by means of a number of shoulders in both the axially forward direction and the rearward direction. These shoulders are explained below in succession from front to rear.

The front shoulder 93 projects beyond the bearing housing 23. One end of an elastic bellows is put over this front shoulder 93. The other end of the bellows is put over a front drive shaft half of the two-part drive shaft 10, so that an interior of the output pinion 18 and thus a joint accommodated in it or a grease filling provided for the latter is protected from dirt and splash water. The rear drive shaft half of the drive shaft 10 is connected to the front drive shaft half by means of shaft splining. Slight axial displaceability of the two drive shaft halves in relation to one another is made possible.

A rotary shaft seal, the outer periphery of which is pressed into the divided bearing housing 23, so that the interior supplied with lubricant of the bearing housing 23 is sealed to the outside, is mounted on a second shoulder following the front shoulder 93. Said lubricant serves for lubricating the two tapered-roller bearing assemblies in an x arrangement and the meshing between the two bevel gears. For lubricant supply, the transmission output shaft 13 comprises, in addition to a central lubricant duct 35, a transverse bore 36, by means of which lubricant and coolant is conducted from the central lubricant duct 35 into the annular channel. From here, part flows flow through supply bores 37, 38, 39 drilled radially into the spur gear of the driving pinion 17. These supply bores 37, 38, 39 extend on the one hand to the two tapered-roller bearings of the tapered-roller bearing assembly of the driving pinion 17 and on the other hand to the meshing between the two bevel gears.

The second shoulder is followed by a third shoulder 98, which receives a bearing inner ring 33. This bearing inner ring 33 is supported axially in the rearward direction, on the third shoulder, which is followed by said central region with the greatest diameter. This region is followed, via a shoulder, by a journal 87. Located on this journal 87 is a bearing inner ring 34 of the tapered-roller bearing assembly of the output pinion 18, which ring is supported on the shoulder toward the front in the axial direction, so that the two tapered-roller bearings belonging to the bearing inner rings 33, 34 are braced in relation to one another in an x arrangement.

Two longitudinal slots 96a and 96b, which are disposed diametrally opposite one another, are milled into the central region of the shaft insert 86. In idealized circumstances, the longitudinal slots 96a and 96b have a rectangular area, the inside radii being of a production engineering nature. In each case two bearing cassettes 95a, 95b are arranged in each of these longitudinal slots 96a and 96b, only one of which can be seen per longitudinal slot 96a, 96b in FIG. 2. A ball pin 94a, 94b of the drive shaft 10 is accommodated pivotably and longitudinally displaceably in each longitudinal slot 96a, 96b by means of these two bearing cassettes 95a and 95b.

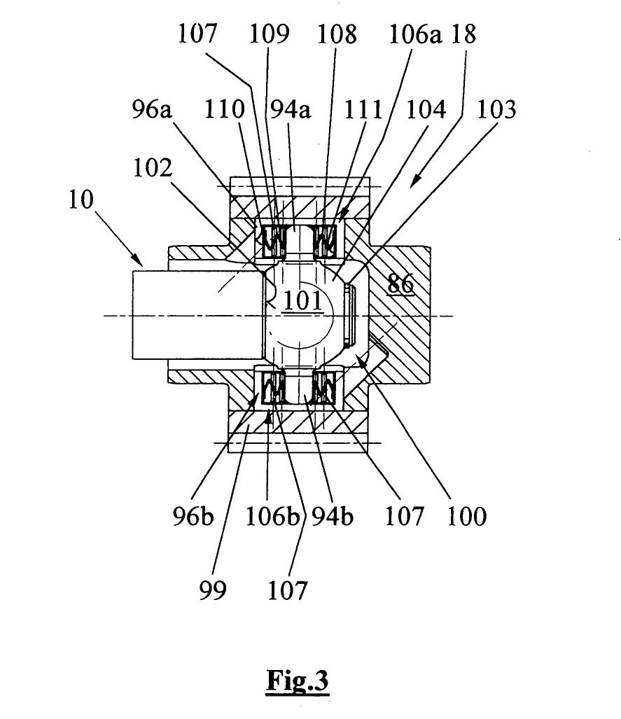

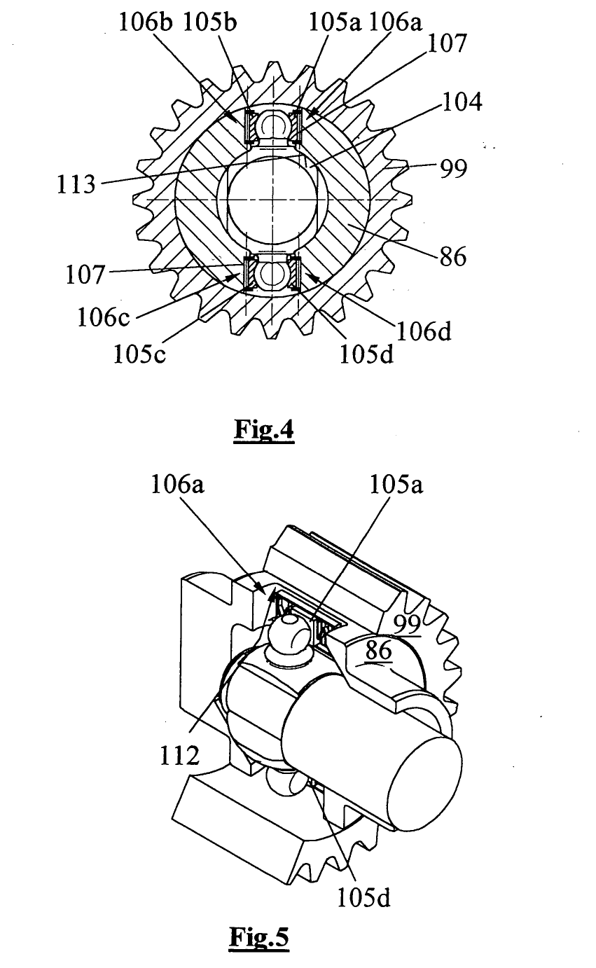

In the following, the joint according to FIG. 3 to FIG. 5 is explained in greater detail. In this connection, FIG. 3 shows the joint from FIG. 2 in detail. FIG. 4 shows the joint of FIG. 3 in a section which extends at right angles to the section of FIG. 2 and FIG. 3. FIG. 5 shows the joint of FIG. 2 to FIG. 4 in a perspective view. To simplify the illustration, the output pinion 18 is not shown as a conical gearwheel but simply as a spur gear.

At its rear end, the rear drive shaft half of the drive shaft 10 is, via a shoulder, designed as a spline shaft journal 100. A hollow-drilled internally toothed ball head 104 is fitted onto this spline shaft journal 100 and consequently connected in a rotationally fixed manner. The ball head 104 bears in the forward direction against the shoulder 102 of the rear drive shaft half and is axially secured at the front end of the spline shaft journal 100 by means of an axial securing ring 103, which is inserted into a circumferential groove of the spline shaft journal. The ball head 104 is flattened by means of milling machining on the bearing surface for the axial securing ring 103 and on the bearing surface for the shoulder 102. If the ball head 104 is a cast part, it may already be formed with two diametrally opposite flat surfaces 101 during casting. The two ball pins 94a and 94b, which are positioned diametrally in relation to one another and made in one piece with the ball head 104, are arranged offset at an angle of 90° in relation to these lateral surfaces 101. The two ball pins 94a and 94b are triple-flattened.

The result of designing the ball head 104 as a separate—i.e. separate from the rear drive shaft half—component is that assembly of the complete biplane joint is simplified. During assembly, the ball head is thus first introduced through the large circular opening, and then the rear drive shaft half is inserted into the ball head 104 and secured with the prestressed axial securing ring 103. When the end position is reached, the axial securing ring snaps out, and the biplane joint is assembled.

In both directions of rotation of the drive shaft 10, the two ball pins 94a and 94b are supported with their spherical caps on pressure distribution blocks 105a, 105b, 105c, 105d. The pressure distribution blocks 105a, 105b, 105c, 105d are for this purpose correspondingly concavely shaped in the region of contact with the spherical caps and arranged longitudinally displaceably in the longitudinal slots 96a and 96b. Each of the four pressure distribution blocks 105a, 105b, 105c, 105d belongs to one of the four bearing cartridges 106a, 106b, 106c, 106d.

In addition to the pressure distribution block 105a, 105b, 105c, 105d, such a bearing cartridge 106a, 106b, 106c, 106d comprises a number of needle rollers 107, two leaf spring elements 108, 109 and a needle bearing cage, which holds the complete bearing cartridge 106a, 106b, 106c, 106d together.

The pressure distribution block 105a, 105b, 105c, 105d is mounted on the needle rollers 107 in a rolling manner in relation to the longitudinal wall of the longitudinal slot 96a, 96b. In addition to the region in which the needle bearing cage accommodates the needle rollers 107, the needle bearing cage also has a frame which surrounds all the components and in which the pressure distribution block 105a, 105b, 105c, 105d is guided longitudinally displaceably and supported elastically in the longitudinal direction by means of the two leaf spring elements 108, 109. The front leaf spring element 109 is supported on the one hand on the pressure distribution block 105a, 105b, 105c, 105d and on the other hand on the front inner wall 110 of the frame. The rear leaf spring element 108 is supported on the one hand on the pressure distribution block 105a, 105b, 105c, 105d and on the other hand on the rear inner wall 111 of the frame. The frame itself is supported in the longitudinal direction on the inside radii 112 of the longitudinal slot 96a, 96b.

In particular FIG. 4 shows that the ball head 104 is accommodated or centered in an articulated manner in the inner wall 113 of the shaft insert 86. To this end, the partly spherical surface of the ball head corresponds to the partly cylindrical inner wall 113 of the shaft insert 86.

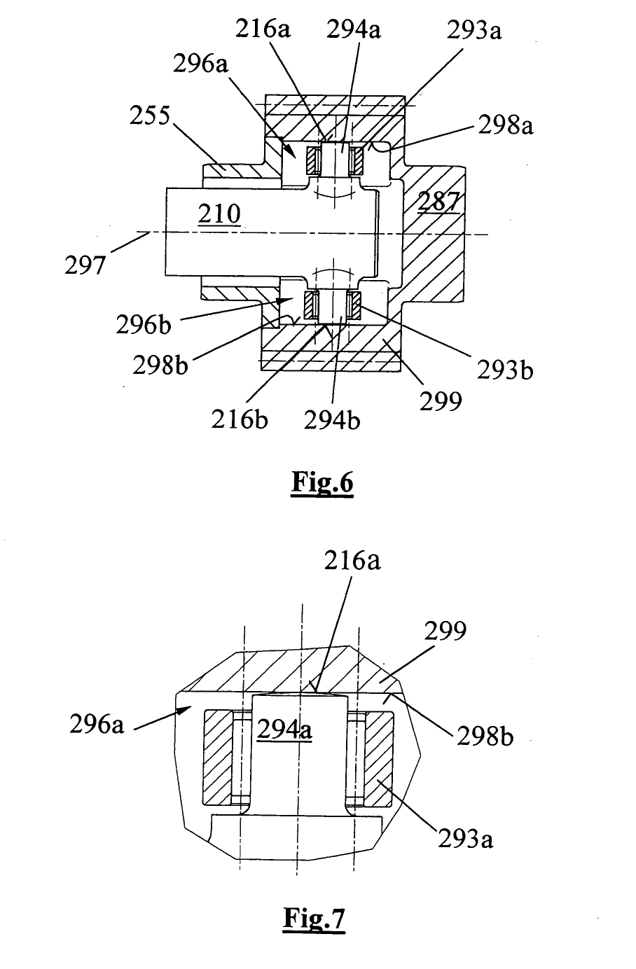

FIG. 6 and FIG. 7 show a second alternative embodiment of the bipod joint. In contrast to the previous illustrative embodiment, guidance is not provided via a separate ball head. The rear drive shaft half 210 is a one piece structure with two diametrally oppositely arranged cylindrical journals 294a and 294b. These journals 294a and 294b are designed with a spherical cap shape on their radially outer end faces 216a and 216b, so that centering of the rear drive shaft half 210 inside the gearwheel 299 takes place on this contact surface pairing. When swiveling movements of the rear propeller shaft half 210 in relation to the gearwheel 299 take place, one spherical cap consequently rolls in relation to the inner wall 298a or 298b. To this end, the two spherical caps are part segments of one and the same imaginary sphere, the central point of which lies on the longitudinal axis 297 of the propeller shaft half 210.

Needle rollers, which support a radially externally arranged cylindrical ring 293a, 293b arranged rollably in the longitudinal direction on the inner walls of the longitudinal slot 296a, 296b, roll directly on the journal 294a, 294b coaxially. The ring 293a, 293b has play in relation to the longitudinal slot 296a, 296b in order to prevent jamming. Depending on the direction of rotation, the ring 293a, 293b consequently rolls only on one inner wall of the longitudinal slot 296a, 296b assigned to this ring. In addition to this rolling, the ring 293a, 293b also performs sliding movements in relation to the respective inner wall of the longitudinal slot 296a, 296b when tilting movements of the propeller shaft half 210 take place.

In this alternative development of the bipod joint, the gearwheel 299 is made in one piece with the journal 287 for the rear bearing assembly of the output pinion in the bearing housing (not shown in FIG. 6). Instead of the shaft insert according to the previous illustrative embodiment, a hollow stop-bush-shaped cover 255 is provided for receiving the second tapered-roller bearing. The rear propeller shaft half 210 projects through this cover 255. The cover 255 is inserted into a guide bore of the gearwheel 299 and welded together with the gearwheel, so that microslip is reliably excluded even in the case of high driving torque transmission.

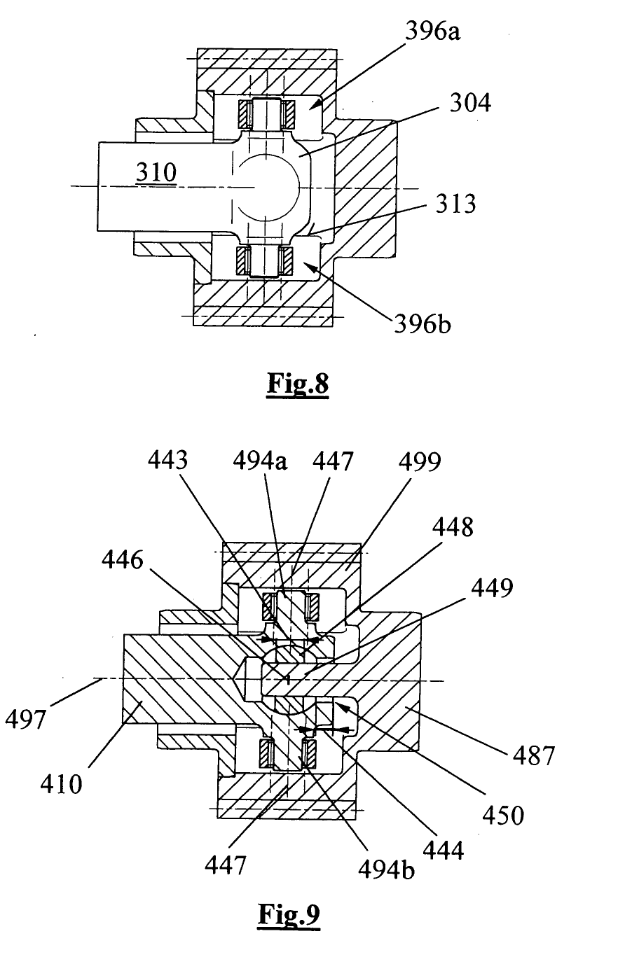

FIG. 8 shows a third alternative development of the bipod joint. In this connection, centering takes place in accordance with the centering according to the first illustrative development by means of a central ball head 304, which is guided pivotably in a cylindrical inner wall 313 of the output pinion. However, the ball head 304 is made in one piece with the rear drive shaft half 310. The rolling/sliding mounting of the rear propeller shaft half 310 in the longitudinal slots 396a, 396b of the output pinion is effected similarly to in the previous illustrative embodiment.

FIG. 9 shows a fourth alternative embodiment of the bipod joint, which differs from the previous illustrative embodiment only in the nature of the centering.

For centering, the rear drive shaft half 410 has on its end side at the rear end a central blind hole bore 450. This blind hole bore 450 is provided approximately centrally axially with a ball-shaped recess. A guide pin 449, onto which a ring 448 with a ball-shaped lateral surface is fitted in the region of the ball-shaped recess, extends into this blind hole bore 450 coaxially with the longitudinal axis 497. This ball-shaped lateral surface forms a fit with said ball-shaped recess. The guide pin 449 is at its rear end made in one piece with the journal 487 of the gearwheel 499.

The central point 446 of the ball-shaped recess—and thus of the ball-shaped lateral surface as well—lies on a longitudinal axis 447 of the two pins 494a and 494b. The drive shaft half 410 is consequently guided pivotably about this central point 446.

In order for it to be possible to introduce the ring 448 into the ball-shaped recess during assembly, the entrance opening of the blind hole bore 450 has a slot (not shown in the drawing) which
extends in a plane at right angles in relation to the longitudinal axis 497 of the rear drive shaft half 410,
has the depth 444 of an entrance opening of the blind hole bore 450 and
has a width which is slightly greater than the thickness 443 of the ring 448.

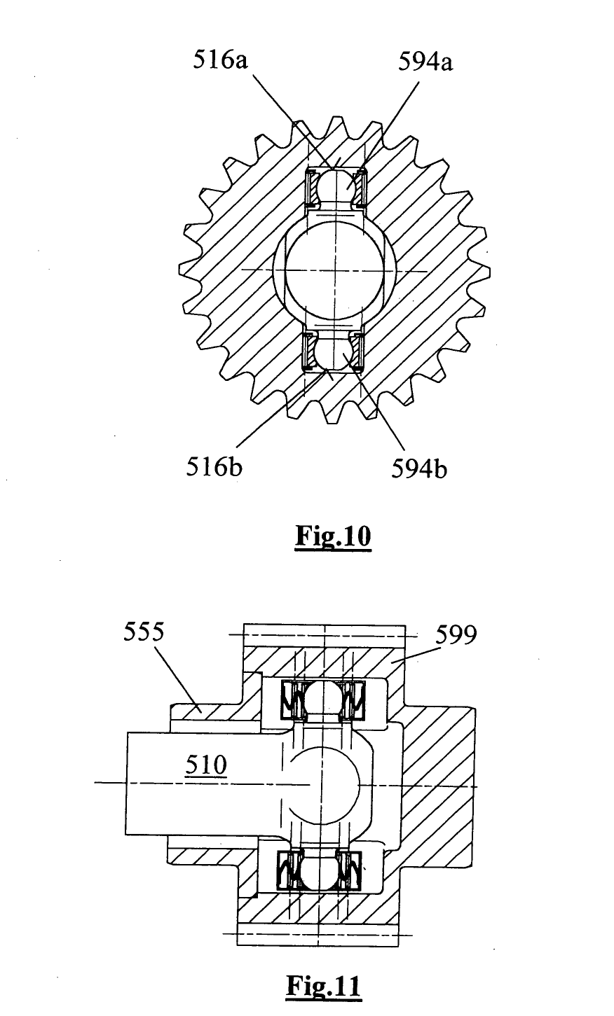

FIG. 10 and FIG. 11 show another embodiment of the biplane joint according to the first illustrative development.

In contrast to the first illustrative embodiment, the two ball pins 594a and 594b arranged diametrally in relation to one another are flattened only on the common radially outermost region 516a and 516b. As assembly of the biplane joint is carried out according to the assembly of the bipod joint of the second and third illustrative embodiments, separation of the ball pin as a separate component from the drive shaft half 510 is not necessary. Assembly is effected by the rear drive shaft half 510 being inserted into the open gearwheel 599 and the cover 555 then being guided over the rear propeller shaft half 510. The cover 555 is then welded together with the gearwheel 599.

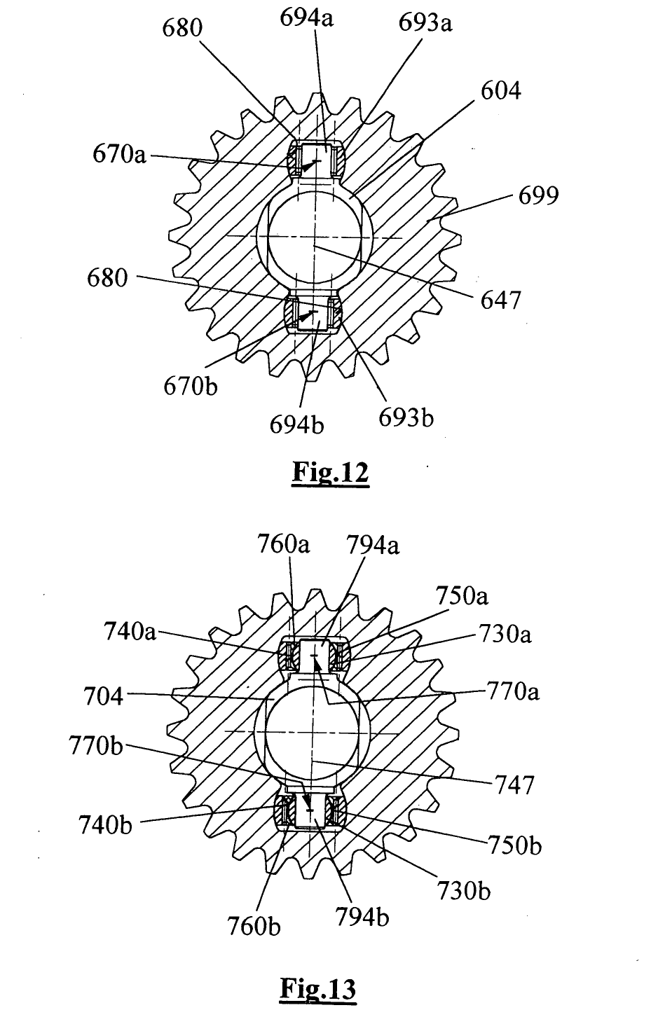

FIG. 12 shows a bipod joint which includes constructional elements
of the bipod joint according to FIG. 8 and
of the biplane joint according to FIG. 10. The guidance of the ball head 604 inside the gearwheel 699 thus corresponds to the guidance of the biplane joint according to FIG. 10 and of the bipod joint according to FIG. 8. A ring 693a, 693b, which is needle-mounted coaxially on the pin 694a or 694b respectively, is outwardly curved or convex on its outer surface. This curved outer surface rolls on a corresponding concavely curved guideway 680 of the longitudinal groove. In this connection, the curved outer surface of the ring 693a, 693b is spherical, the central point 670a, 670b of this spherical shape lying approximately centrally in the pin 694a, 694b on its longitudinal axis 647. When tilting movements of the rear propeller shaft half or of the ball head 604 made in one piece with it take place, the pins 694a and 694b are displaced in relation to the rings 693a, 693b axially along the longitudinal axis 647. In this connection, the sliding movements take place on the contact surfaces of the ring 693a, 693b and of the pin 694a, 694b with the needle rollers.

FIG. 13 shows a bipod joint which has been developed further in relation to the previous bipod joint. Here, in contrast to the previous illustrative embodiment, the needle bearing does not roll directly on the pin 794a, 794b but on a further rolling bearing inner ring 760a, 760b. For guiding the needle bearing bodies, this rolling bearing inner ring 760a, 760b is designed cylindrically on its outer lateral surface 750a, 750b and recessed spherically concavely on its inner surface. This concave inner surface is in turn mounted slidingly in relation to a convex outer surface 740a, 740b of a sliding bearing inner ring 730a, 730b. The central point 770a, 770b of the various concave and convex surfaces lies approximately centrally in the pin 794a, 794b on its longitudinal axis 747. The complete needle bearing assembly can consequently pivot about this central point 770a, 770b. When tilting movements of the rear propeller shaft half or of the ball head 704 made in one piece with it take place, the pins 794a, 794b are displaced in relation to the complete needle bearing axially along the longitudinal axis 747. In this connection, the sliding movements take place on the contact surfaces of the pin 794a, 794b with the sliding bearing inner ring.

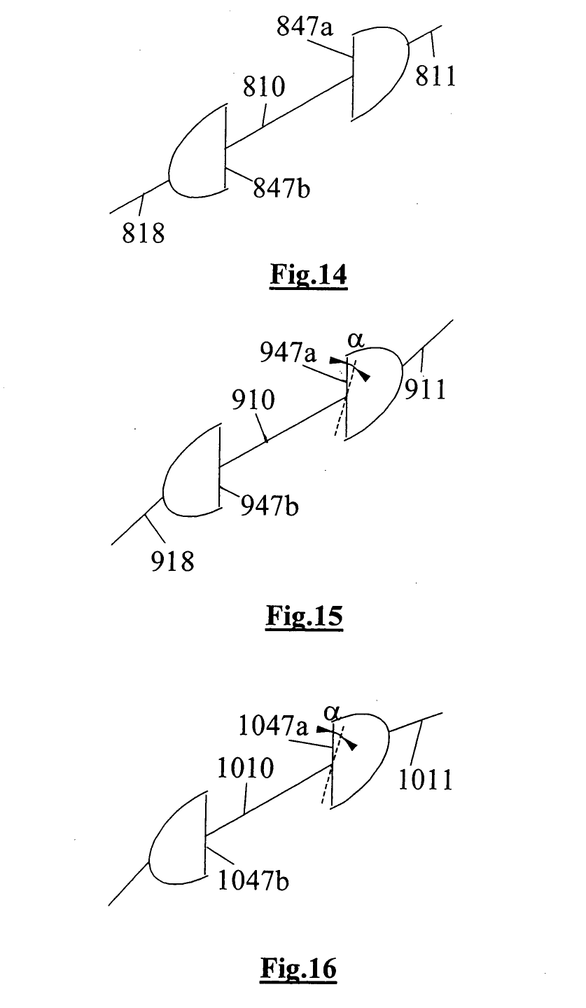

FIG. 14 shows very diagrammatically a lateral shaft 810 or drive shaft which is aligned with
the pinion shaft 811 of the front axle transmission and
the output pinion 818.
   The two pin longitudinal axes 847a and 847b are arranged parallel to one another.

FIG. 15 shows very diagrammatically a lateral shaft 910 or drive shaft in a Z arrangement. Here, the pinion shaft 911 of the front axle transmission and the output pinion 918 are arranged at an angle to the lateral shaft 910 and orientated approximately in the same direction. The two pin longitudinal axes 947a and 947b are not arranged exactly parallel to one another but have a small compensation angle α in relation to one another.

FIG. 16 shows very diagrammatically a lateral shaft 1010 or drive shaft in a W arrangement. Here, the pinion shaft 1011 of the front axle transmission and the output pinion 1018 are arranged at an angle to the lateral shaft 1010. The two pin longitudinal axes 1047a and 1047b are not arranged exactly parallel to one another but have a small compensation angle α in relation to one another.

Further developments of the bipod joint according to second, third and fourth embodiments, i.e. FIG. 5 to FIG. 9, are not illustrated in the drawing. In this case, instead of the two cylindrical rings, which roll on the one hand via the needle rollers and on the other hand on the plane inner walls of the longitudinal slots, two curved rings are provided. These curved rings are shaped concavely on the outer lateral surface. On the other hand, the longitudinal slots remain plane in these embodiments. When torque transmission of the propeller shaft takes place, punctual forces thus arise in idealized circumstances at the force transmission locations between the curved rings and the plane inner walls. Owing to the pressing in these two locations, a contact surface appears in reality instead of the point contact. While a smaller torque can be transmitted with such curved rings than with the cylindrical rings, the torque on the propeller shaft is nevertheless relatively small anyway as
the torque in the drive shaft amounts to only 30% to 45% of the transmission output shaft torque anyway as more than half of the transmission output shaft torque is always conducted to the rear axle and
the high output torque on the front axle is only brought about by the transmission ratio on the bevel pinion/ring gear gearing on the front axle differential.

By virtue of the geometries illustrated in the illustrative embodiments, the drive train for a four wheel-driven motor vehicle can be integrated in a space-saving way in a narrow vehicle tunnel.

Depending on constructional space conditions, other angles are also conceivable instead of the horizontal angle of roughly 8° indicated for the first illustrative embodiment and the vertical angle of 4°.

The driving pinion and the output pinion of the lateral output can also be designed alternatively as spiral bevel gears or as contrate gears instead of as conical spur gears.

The developments described are only examples. A combination of the features described for different embodiments is likewise possible.

1. A longitudinally installed four wheel drive train for a motor vehicle having an engine and a transmission with a transfer gearing and with front and rear drive shafts extending in the longitudinl direction of the vehicle, wherein a driving torque can be transmitted from the vehicle transmission (19) via the transfer gearing (29) and a gear wheel (99) to a front drive shaft (10), the rear end of the front drive shaft (10) being arranged in an articulated manner inside the gearwheel (99) so as to form a first joint (100) and comprising two pins (94a, 94b) arranged diametrically relative to one another and extending into longitudinal grooves (96a, 96b) formed inside the gearwheel (99) so as to be axially displaceable in the gear wheel (99) and pivotably supported therein.

2. The four wheel drive train as claimed in claim 1, wherein the front drive shaft (10) is at its front end connected to a pinion shaft (11) of a front axle differential (15) by means of a second joint (101).

3. The four wheel drive train as claimed in claim 2, wherein the front drive shaft (10) also comprises two pins arranged diametrally opposite to one another in the second joint (101).

4. The four wheel drive train as claimed in claim 3, wherein the two pins (94a, 94b) assigned to the rear end of the front drive shaft have longitudinal axes, which extend parallel to the longitudinal axes of the pins of the front end of the drive shaft (10).

5. The four wheel drive train as claimed in claim 3, wherein the pinion shaft (11), the front drive shaft (10) and the gearwheel (99) are arranged in relation to one another with respect to their axes of rotation such that the longitudinal axes of the front drive shaft (10) is inclined by in relation to the longitudinal axes of the pinion shaft and the gear wheel (99) (Z or W arrangement) and the longitudinal axes of the pins (4a, 94b) are inclined by only a small compensation angle α with respect to the pins at the front end of the front drive shaft (10).

6. The four wheel drive train as claimed in claim 1, wherein the two pins (94a, 94b) at the opposite ends of the front drive shaft (10) are firmly connected to the front drive shaft (10).

7. The four wheel drive train as claimed in claim 1, wherein the pins (94a, 94b) assigned to the front drive shaft end are guided in a rolling manner in the longitudinal grooves by means of non-friction bearings (needle bearings).

8. The four wheel drive train as claimed in claim 7, wherein the non-friction bearing assigned to the pins (294a, 294b) is arranged coaxially with the pin (294a, 294b), the bearing including a rolling ring (293a, 293b) disposed in the longitudinal groove.

9. The four wheel drive train as claimed in claim 8, wherein the longitudinal groove has concave guide walls (680) and the rolling ring (293a, 293b) has a corresponding convexly shaped portion.

10. The four wheel drive train as claimed in claim 8, wherein a ball head bearing arrangement (ring 730a, 730b) is arranged between the pin (794a, 794b) and the antifriction bearing.

11. The four wheel drive train as claimed in claim 7, wherein the ring (94a, 94b) is provided with two linear bearing cartridges (95a and 95b), which roll on guide walls of the longitudinal groove (96a, 96b).

12. The four wheel drive train as claimed in claim 11, wherein elastic stop structures are provided at the ends of the longitudinal grooves forming stops for the pins.

13. The four wheel drive train as claimed in claim 12, wherein leaf spring elements (108 and 109) are provided in combination with a rolling bearing cage of the linear bearing cartridges (95a, 95b) to form a subassembly which can be preassembled.

14. The four wheel drive train as claimed in claim 11, wherein the pin (94a, 94b) is supported in ball joint fashion in relation to the linear bearing of the bearing cartridges.

15. The four wheel drive train as claimed in claim 1, wherein the longitudinal grooves are closed at their ends in the gearwheel by means of a journal (287) formed in one piece with the gearwheel (299) and by means of an annular cover (255), the cover (255) being welded together with the gearwheel (299) and comprising a further journal, and the two journals forming a bearing support structure for the gearwheel (299).

16. The four wheel drive train as claimed in claim 2, wherein the second joint is a universal joint.
